(19) United States
(12) Patent Application Publication
(10) Pub. No.: US 2026/0358280 A1
(43) Pub. Date: Nov. 12, 2026

(54) WIRE-FREE SPARK INITIATOR AND RELATED METHODS

(71) Applicant: The Boeing Company, Arlington, VA (US)

(72) Inventor: Shahriar Khosravani, Everett, WA (US)

(21) Appl. No.: 19/205,810

(22) Filed: May 12, 2025

(51) Int. Cl. G01N 27/04; B64F 5/60

(52) U.S. Cl. CPC G01N 27/041; B64F 5/60

(57) ABSTRACT

A wire-free spark initiator for performing lightning testing on a substrate includes an auxiliary power source that is high-voltage and low current, and that produces a sufficiently high initial voltage to establish a spark and an initial plasma channel on the substrate. A dielectric disk rotates with respect to the substrate, and includes first and second opposing sidewalls, and a circumferential surface extending between the sidewalls. A high-voltage electrode is positioned inside the dielectric disk, and a main high-voltage power source having a capacitor bank assembly and a dielectric ball is coupled to a distal end of a probe of the main high-voltage power source. The dielectric ball is positioned adjacent the circumferential surface of the dielectric disk. Rotation of the dielectric disk mechanically stretches the initial plasma channel to form an elongated stretch of plasma that reaches from the substrate to the probe of the main high-voltage power source.

### FIELD

The present disclosure relates generally to a wire-free spark initiator, and more particularly to initiating sparks for direct lightning effect testing.

### BACKGROUND

Direct lightning effect testing subjects a system or a component to high current pulses to test the effects on materials of the system or its components. For example, an aircraft may be required to pass a direct lightning effect test standard before the aircraft is certified for operation. Other systems may also be subjected to direct lightning effect testing, such as wind turbines, architectural features, etc.

The direct lightning effect testing of composite substrates requires initial sparking. The current method is based on adding a sacrificial thin wire to connect a high-voltage probe to a substrate under test (SUT). Because composite substrates often have a high dielectric coating (e.g., multiple layers of paint), and because testing devices cannot safely imitate lightning with a high enough voltage to penetrate the dielectric coating, the surface of the substrate must be pricked down to the conductive composite in order to conduct such testing. This prick of the surface tends to modify the initial real test condition and influence the results because the coating surface is pricked at the user's predetermined location, which in turn defines the pathway of the spark (rather than in a realistic case where lightning determines its own path). Furthermore, the sacrificial guide wire is an artificial addition to the substrate being tested. The conventional approach therefore introduces an unrealistic forced boundary condition which may skew the test results.

### SUMMARY

Presently disclosed high-voltage wire-free spark initiators for direct lightning effect testing of composite substrates with high dielectric coatings and/or paint layers may eliminate the need for sacrificial connecting wires and pricking the surface altogether. Disclosed devices may include an auxiliary high-voltage, low-current pulse power source with a sufficiently initial high voltage to establish sparking and an initial plasma channel to a substrate under test (SUT, or merely “substrate”). Disclosed devices may mechanically stretch the plasma to reach a main high-voltage probe, while quickly lowering the voltage level to be safe for a capacitor bank assembly of a main power source (typically below 50kV max). Thus, disclosed spark initiators and systems including the same may eliminate the need for pricking top dielectric layer(s) as well as the need for a sacrificial guide wire to a main capacitor bank electrode. Disclosed devices may utilize the high conductivity of air in a plasma state, which effectively performs like a thin electric wire.

In an example, a high-voltage wire-free spark initiator for performing lightning testing on a substrate includes an auxiliary power source, a dielectric disk configured to be rotated with respect to the substrate, a high-voltage electrode positioned inside the dielectric disk, and a main high-voltage power source comprising a capacitor bank assembly and a dielectric ball coupled to a distal end of a probe of the main high-voltage power source. The auxiliary power source is a high-voltage and low current power source that produces a sufficiently high initial voltage to establish a spark and an initial plasma channel on the substrate. The dielectric disk may include first and second opposing sidewalls and a circumferential surface extending between the first and second opposing sidewalls. The dielectric ball may be positioned adjacent the circumferential surface of the dielectric disk, and rotation of the dielectric disk may be configured to mechanically stretch the initial plasma channel to form an elongated stretch of plasma that reaches from the substrate to the probe of the main high-voltage power source.

Related methods also are within the scope of the present disclosure, and may include sparking an initial plasma channel via an auxiliary power source of a spark initiator and mechanically stretching the initial plasma channel to form an elongated stretch of plasma by spinning a dielectric disk relative to the substrate under test.

### BRIEF DESCRIPTION OF THE DRAWINGS

FIG. 1 is a schematic representation of non-exclusive examples of spark initiators according to the present disclosure and systems including the same.

FIG. 2 is a side elevation schematic representation of non-exclusive examples of spark initiators according to the present disclosure and systems including the same.

FIG. 3 is a side elevation schematic representation of non-exclusive examples of spark initiators according to the present disclosure and systems including the same.

FIG. 4 is a perspective schematic representation of non-exclusive examples of spark initiators according to the present disclosure and systems including the same.

FIG. 5 is a side elevation schematic representation of non-exclusive examples of spark initiators according to the present disclosure and systems including the same.

FIG. 6 is a perspective schematic representation of non-exclusive examples of spark initiators according to the present disclosure and systems including the same.

FIG. 7 is a perspective view showing the results of use of a spark initiator according to the present disclosure.

FIG. 8 is a schematic flowchart diagram illustrating methods according to the present disclosure.

FIG. 9 is a side elevation schematic representation of non-exclusive examples of spark initiators according to the present disclosure and systems including the same.

### DESCRIPTION

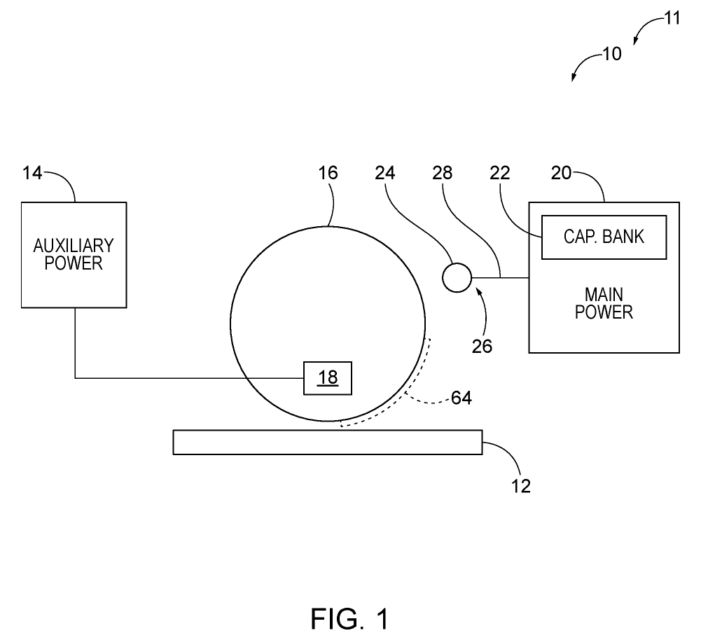

FIGS. 1-6 and 9 provide illustrative, non-exclusive examples of high-voltage, wire-free spark initiators 10 (also referred to herein simply as spark initiators 10) according to the present disclosure, as well as systems 11 including the same. Elements that serve a similar, or at least substantially similar, purpose are labeled with like numbers in each of FIGS. 1-6 and 9, and these elements may not be discussed in detail herein with reference to each of FIGS. 1-6 and 9. Similarly, all elements may not be labeled in each of FIGS. 1-6 and 9, but reference numerals associated therewith may be utilized herein for consistency. Elements, components, and/or features that are discussed herein with reference to one or more of FIGS. 1-6 and 9 may be included in and/or utilized with any of FIGS. 1-6 and 9 without departing from the scope of the present disclosure.

In general, elements that are likely to be included in a given (i.e., a particular) example are illustrated in solid lines, while elements that are optional to a given example are illustrated in dashed lines. However, elements that are shown in solid lines are not essential to all examples, and an element shown in solid lines may be omitted from a particular example without departing from the scope of the present disclosure.

With reference to FIG. 1, disclosed spark initiators 10 are high-voltage spark initiators that may be used, for example, for performing lightning testing (e.g., direct lightning effect testing) on a substrate 12 under test (referred to herein as SUT 12 or substrate 12). Disclosed systems 11 include spark initiator 10 and substrate 12. Spark initiators 10 include an auxiliary power source 14 that is a high-voltage, low current power source that produces a sufficiently high initial voltage to establish a discharge, or spark, and an initial short plasma channel at a high-voltage electrode 18 positioned within a dielectric disk 16. Dielectric disk 16 that is rotated with respect to substrate 12 and with respect to high-voltage electrode 18 positioned inside dielectric disk 16. Dielectric disk 16 is a non-conducting hollow disk in some examples. High-voltage electrode 18 is electrically coupled to auxiliary power source 14 and creates the initial spark and initial plasma channel within dielectric disk 16. A main high-voltage power source 20 (also referred to herein as main power source 20) has a capacitor bank assembly 22 and a dielectric ball 24 coupled to a distal end 26 of a probe 28 of main high-voltage power source 20. Dielectric ball 24 is positioned adjacent a circumferential surface 30 on the outside of dielectric disk 16 and may be configured to deflect the acoustic shock wave from the sudden electrical discharge created by spark initiator 10.

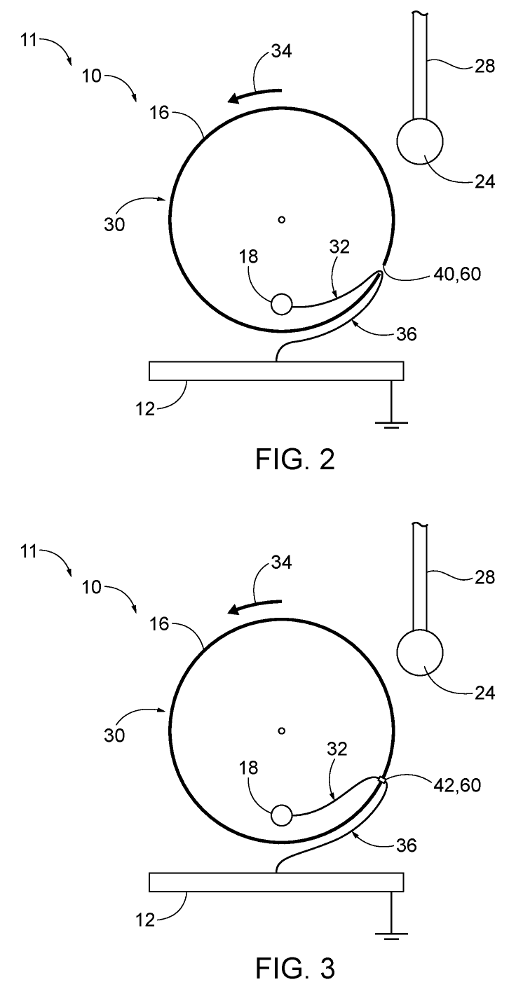

Because dielectric disk 16 is rotated with respect to the point where the plasma is initiated (e.g., electrode 18), rotation of dielectric disk 16 mechanically stretches (e.g., pulls) an initial plasma channel 32 (FIGS. 2-6) to form an elongated stretch of plasma 36 (FIGS. 2-6) that reaches to substrate 12. In some examples, the plasma discharge may be sustained by using lower voltages to make a long spark, such as around 30kV/cm in a non-limiting example. Because plasma channels 32, 36 are electrically charged gas, they can be pulled and stretched in this manner, to effectively serve the same function as the sacrificial wire in conventional devices. Plasma 32, 36 also acts as a resistive path, causing the initially high voltage to be lowered by the time it reaches main power source 20, as described herein.

Initial plasma channel 32 is only permitted to pass through circumferential surface 30 at a specific point 60. Examples discussed herein include only a single point 60 in dielectric disk 16, though examples including two or more such points 60 also are within the scope of the present disclosure. Point 60 may be, for example a pinhole or other through-hole formed through circumferential surface 30, and/or may be a conductor (e.g., a metallic rod or other shaped conductor) that passes or extends through circumferential surface 30. As dielectric disk 16 is rotated, the relative motion of point 60 with respect to electrode 18 and substrate 12 elongates initial plasma channel 32, and forms an elongated, or stretched, plasma channel 36 that extends through point 60 to substrate 12. Specifically, rotation of dielectric disk 16 may induce a simple circular arc shape of the plasma as it is stretched, as opposed to a typical bifurcated fractal pattern of sparking that is obtained using conventional devices.

In a non-limiting example, auxiliary power source 14 may have a peak output current of about 1 milliamp (mA) and a peak voltage of about 150 kilovolts (kV). Spark initiator 10 is configured to lower the high initial voltage from auxiliary power source 14 (e.g., over 100 kV) to a lower voltage (e.g., 50 kV or less) that is safe for capacitor bank assembly 22 of main power source 20. Thus, while auxiliary power source 14 is configured to provide a high enough initial voltage to create a spark without requiring a sacrificial wire and without pricking the surface of substrate 12, the arrangement of spark initiator 10 lowers the voltage before it reaches capacitor bank assembly 22 to prevent damage to capacitor bank assembly 22 and main power source 20. For example, a capacitive discharge of probe 28 may decrease rapidly when the initial plasma channel is stretched via rotation of dielectric disk 16 due to a limited current supply of main power source 20 and/or impedance and voltage divider effects of disclosed spark initiators 10. Capacitor bank assembly 22 generally operates at a lower peak voltage than auxiliary power source 14, whereas the initial voltage produced by auxiliary power source 14 may be sufficiently high to penetrate any dielectric coating of substrate 12. Spark initiators 10 may be configured to reduce the voltage reaching capacitor bank assembly 22 to a level that is determined by the capacity of capacitor bank assembly 22. Suitable lower voltage levels may be less than 50kV, less than 40 kV, less than 30 kV, and/or less than 20kV, though voltage levels may be higher than 50 kV in some examples.

Thus, auxiliary power source 14 electrically couples substrate 12 to capacitor bank assembly 22 via probe 28 near circumferential surface 30 of dielectric disk 16, without damaging capacitor bank assembly 22 with the higher voltage of auxiliary power source 14. For example, the geometry of disclosed spark initiators 10 and the pulse waveform provided by auxiliary power source 14 may be designed and timed correctly to not exceed the 80% of the voltage of capacitor bank assembly 22 of main power source 20 when a main plasma channel 38 attaches to probe 28 going to main power source 20. Because the plasma channel is stretched over time, the local voltage of elongated plasma channel 36 near dielectric ball 24 is reduced below the initial fully charged voltage of capacitor bank assembly 22. As plasma is a conductive medium, capacitor bank assembly 22 initiates a spark to this conductive medium, resulting in main plasma channel 38 electrically coupled to probe 28, with main plasma channel 38 effectively serving as a stretchable wire to capacitor bank assembly 22 and being defined by elongated stretch of plasma 36.

The radius of dielectric disk 16 may be at least partially determined by the upper limit of the current of auxiliary power source 14. The higher the current, the larger the radius of dielectric disk 16 can be. In non-exclusive representative examples, dielectric disk 16 may have a diameter of less than about 5 inches, less than about 6 inches, less than about 7 inches, less than about 8 inches, less than about 9 inches, less than about 10 inches, less than about 11 inches, less than about 12 inches, less than about 15 inches, and/or less than about 20 inches. In some examples, dielectric disk 16 has a diameter of between about 6-10 inches. The positioning and diameter of dielectric disk 16 may be selected to ensure sufficient separation between the dielectric disk and substrate 12 to reduce the acoustic and mechanical shock impact on substrate 12.

Substrate 12 may be a composite substrate having one or more layers of a high dielectric coating and/or paint, and disclosed spark initiators 10 are configured for testing substrate 12 without pricking, puncturing, or piercing through the one or more layers of dielectric coating and/or paint. Additionally, substrate 12 typically is grounded. In non-limiting illustrative examples, substrate 12 may be a component of an aircraft, though in other examples, substrate 12 may be a portion or component of other vehicles or devices, or any material being tested using disclosed spark initiators 10, such as building materials.

With reference to FIGS. 2-4, dielectric ball 24 is positioned adjacent (e.g., within about 1 inch or less away, and/or within about 0.5 inches or less away from) circumferential surface 30 of dielectric disk 16, and initial plasma channel 32 is shown extending from electrode 18 towards point 60 of dielectric disk 16. Rotation of dielectric disk 16 (e.g., in the direction indicated by arrow 34) mechanically stretches initial plasma channel 32 to form elongated stretch of plasma 36 that reaches to substrate 12. Spark initiator 10 may be configured to cause elongated stretch of plasma 36 to jump to probe 28 when probe 28 is near elongated stretch of plasma 36, thereby creating main plasma channel 38 extending from substrate 12 to probe 28 of main power source 20. To allow initial plasma channel 32 to be stretched to substrate 12, some examples of dielectric disk 16 include a through-hole 40 (which is an example of point 60) formed through circumferential surface 30 of dielectric disk 16, as shown in FIG. 2. In these examples, elongated stretch of plasma 36 extends from high-voltage electrode 18 within dielectric disk 16, through through-hole 40, and along circumferential surface 30 of dielectric disk 16 to substrate 12. In such examples, through-hole 40 may include a temperature-resistant dielectric rim, such as a ceramic rim, due to the presence of the hot plasma channel extending through through-hole 40. In other examples, dielectric disk 16 includes a metallic rod 42 (which is another example of point 60) extending through circumferential surface 30, as shown in FIG. 3. In such examples, elongated stretch of plasma 36 extends from high-voltage electrode 18 within dielectric disk 16 to circumferential surface 30 of dielectric disk 16 via conduction by way of metallic rod 42 (whereas circumferential surface 30 is otherwise non-conductive because of being formed of dielectric materials and/or coatings). Metallic rod 42 (or other conductor serving as point 60) serves to electrically bridge electrode 18 and/or an inner dielectric disk 44 to circumferential surface 30 on the outside of dielectric disk 16 in this example.

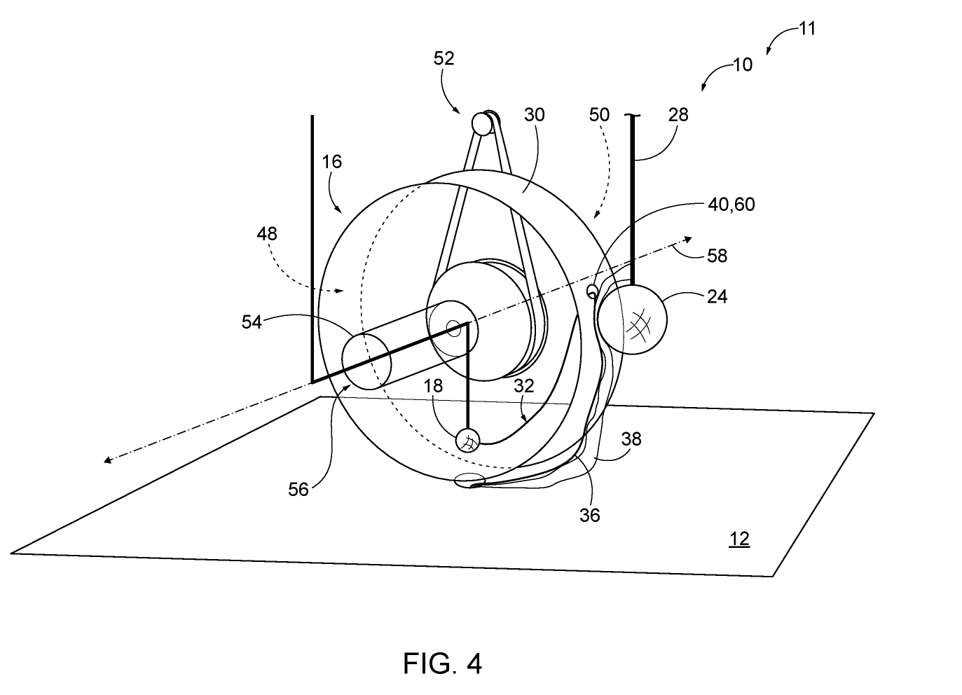

With primary reference to FIG. 4, dielectric disk 16 may include first and second opposing sidewalls 48, 50, with circumferential surface 30 extending between first and second opposing sidewalls 48, 50. Circumferential surface 30 may be a small radius concave surface, such that dielectric disk 16 may be similar in shape or appearance to a bicycle tire rim. In some examples, spark initiator 10 includes a dielectric pulley assembly 52 configured to drive and rotate dielectric disk 16. Dielectric pulley assembly 52 may be electrically isolated. Spark initiator 10 may include a dielectric tube 54 extending through a central portion 56 of dielectric disk 16. For example, dielectric tube 54 may extend longitudinally along an axis 58 about which dielectric disk 16 is rotated. In some examples, high-voltage electrode 18 extends through or is positioned within dielectric tube 54. Pulley assembly 52 may drive dielectric disk 16 through coupling to, for example, dielectric tube 54, first opposing sidewall 48, and/or second opposing sidewall 50.

As dielectric disk 16 is rotated, the relative motion of point 60 with respect to electrode 18 and substrate 12 elongates initial plasma channel 32 and forms the upside-down substantially U-shaped elongated stretch of plasma 36 shown in FIG. 4. The speed of rotation of dielectric disk 16 may be controlled, or selected, to create the desired shape or geometry of elongated plasma channel 36. For example, the speed of rotation of dielectric disk 16 may be based on, or limited by, maintaining the continuity of elongated plasma channel 36. The induced circular or U-shape (as opposed to bifurcated fractal-like shapes produced in conventional lightning testing) is due to the compressibility of plasma (ionized hot air) and the Coanda effect from the spinning dielectric disk 16. Specifically, the Coanda effect causes air around a rotating object to spin with the object, and whatever particulates hit the surface become attached to it and create a boundary layer. As dielectric disk 16 rotates, air is being pulled over circumferential surface 30, thereby creating wind in the same direction as the rotation of dielectric disk 16 and forming plasma channels in a narrow channel shape as shown in the Figures rather than random fractal shapes. The concave outer wall (circumferential surface 30) of the rotating dielectric disk 16 creates a self-converging force by the electric field to maintain the plasma at its lowest point of circumferential surface 30 relative to the center of dielectric disk 16.

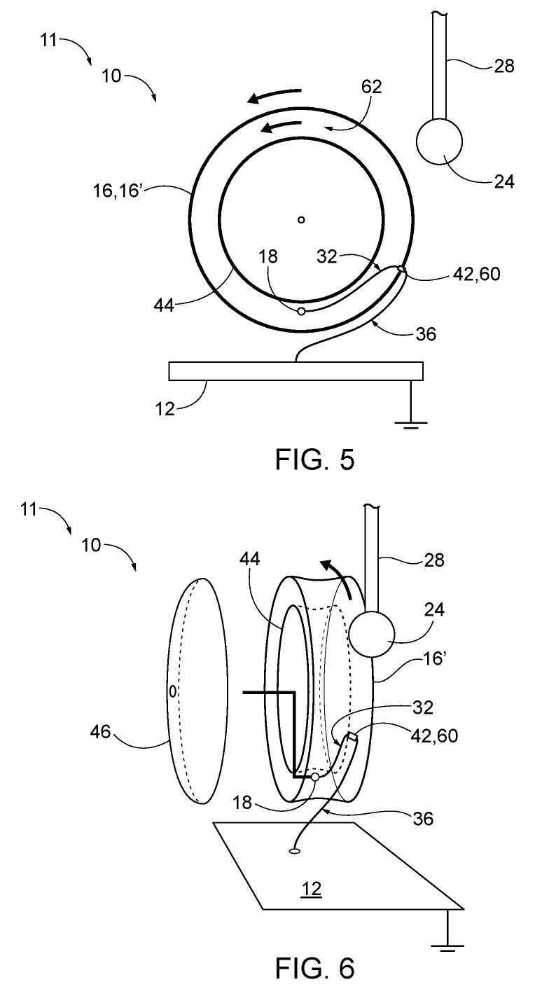

In some examples, such as shown in FIGS. 5 and 6, dielectric disk 16 may be an outer dielectric disk 16’, and spark initiator 10 may also include an inner dielectric disk 44. Inner dielectric disk 44 is positioned within the outer dielectric disk 16’, and high-voltage electrode 18 may be positioned between an inner dielectric disk 44 and outer dielectric disk 16’. One or more end caps 46 may be coupled to dielectric disk 16 (e.g., outer dielectric disk 16’) and/or inner dielectric disk 44. Such end caps 46 may be configured to provide a rotating axis about which dielectric disk 16 rotates and/or to prevent side electrical discharge from electrode 18. Including inner dielectric disk 44 inside the main/outer dielectric disk 16/16’ may create a channel 62 (FIG. 5) that enhances the Coanda effect, allowing the portion of plasma channel 32 inside dielectric disk 16 to maintain its curvature during elongation.

Thus, disclosed spark initiators 10 introduce a high voltage power source (auxiliary power source 14) that can initiate main plasma channel 38 and electrically connect substrate 12 to probe 28 of main power source 20 without damaging capacitor bank assembly 22 (which has a limited top operating voltage, as is understood in the art). Assuming that the resistance of main plasma channel 38 remains fairly constant, the voltage from auxiliary power source 14 is approximately halved at the midpoint of main plasma channel 38. Additionally, the capacitive discharge from electrode 18 will decrease rapidly during the stretching of the plasma due to its limited current supply. In some examples, this ensures that the initial voltage of initial plasma channel 32 and elongated plasma channel 36 is sufficiently high to penetrate any thick dielectric coating of substrate 12, while quickly dropping to a level below that of the capacitor bank assembly 22, which operates at a lower peak voltage. Advantages of disclosed spark initiators 10 and related methods may include improved safety, improved test reliability, more realistically replicating lightning events, avoiding the use of sacrificial wires, and/or creating a guaranteed spark.

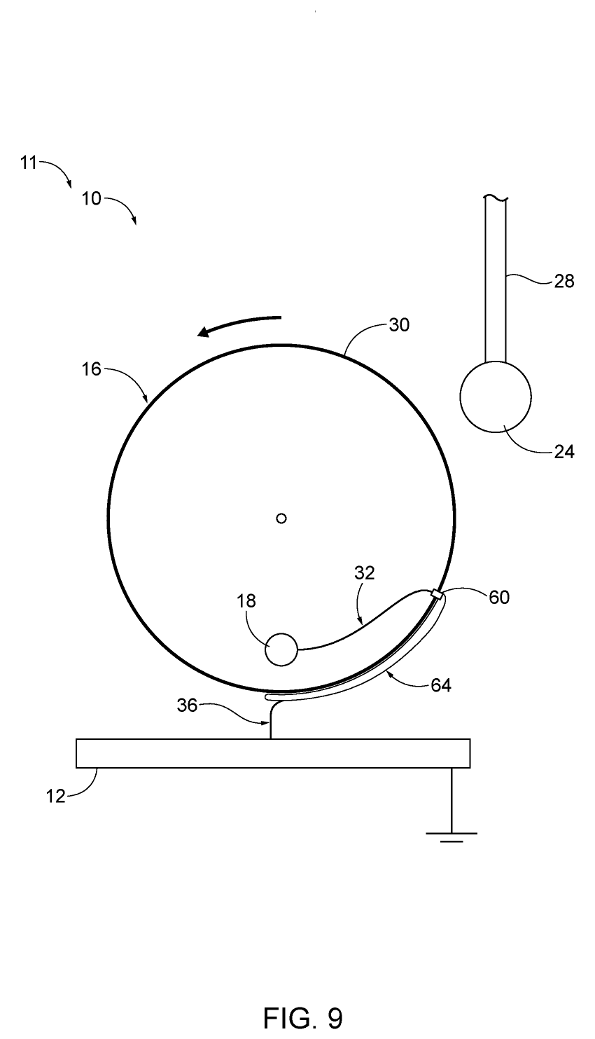

FIG. 9 shows a schematic representation of another example of spark initiator 10, in which a metallic strip 64 extends along a portion of circumferential surface 30. Metallic strip 64 may be configured to control the voltage at a reattachment point to the main capacitor bank assembly 22 (e.g., where main plasma channel 38 jumps to probe 28) to adjust the half-value point in the plasma channel. While the resistance of initial plasma channel 32 may be about equal to the resistance of elongated stretch of plasma 36 in some examples, in the example shown in FIG. 9, the resistance of initial plasma channel 32 within dielectric disk 16 may be greater than the resistance of the elongated stretch of plasma 36 outside of dielectric disk (e.g., the portion extending from point 60 to substrate 12) due to the presence of metallic strip 64. The resistance ratio may be selectively adjustable by selecting, for example, the width, length, and/or thickness of metallic strip 64. In this manner, metallic strip 64 may be configured to provide additional control over the plasma voltage at the reattachment point to capacitor bank assembly 22.

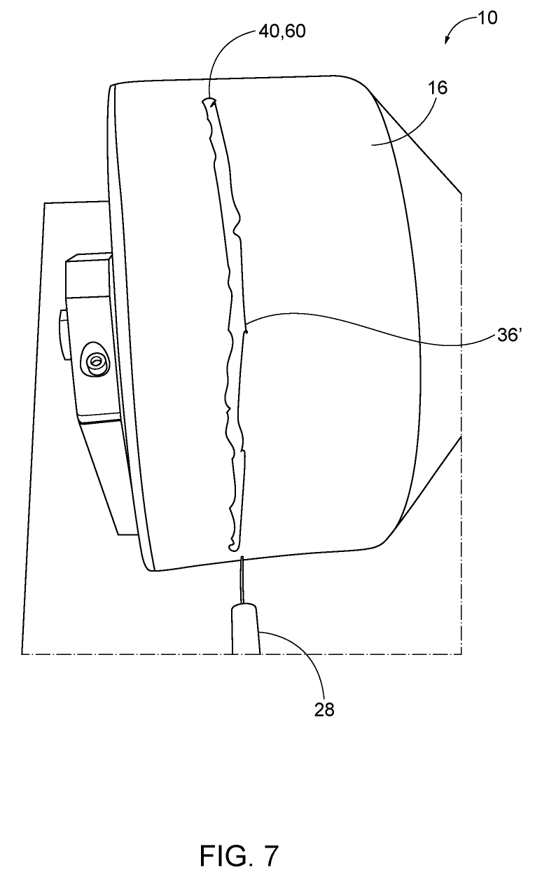

Turning now to FIG. 7, an illustrative non-exclusive example of a result from spark initiator 10 is illustrated. Where appropriate, the reference numerals from the schematic illustrations of FIGS. 1-6 are used to designate corresponding parts in FIG. 7; however, the example of FIG. 7 is non-exclusive and does not limit spark initiators 10 or their resulting plasma channels 36, 38 to the illustrated example of FIG. 7. That is, spark initiators 10 are not limited to the specific example illustrated, and may incorporate any number of the various aspects, configurations, characteristics, properties, etc. of spark initiators 10 that are illustrated in and discussed with reference to the schematic representations of FIGS. 1-6 and/or the example of FIG. 7, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to FIG. 7; however, it is within the scope of the present disclosure that the previously discussed features, variants, etc. may be utilized therewith. FIG. 7 shows an example of dielectric disk 16 after spark initiator 10 has been used to create a spark and plasma channel as described herein. Specifically, a scar 36’ is shown extending from through-hole 40 to a point near probe 28, which corresponds to elongated plasma channel 36 extending to the substrate under test during the test.

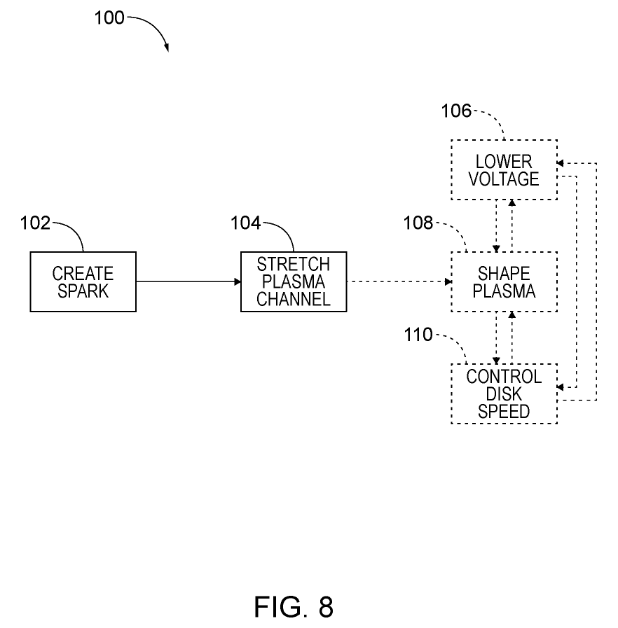

FIG. 8 schematically provides a flowchart that represents illustrative, non-exclusive examples of methods 100 according to the present disclosure. In FIG. 8, some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIG. 8 are not limiting and other methods and steps are within the scope of the present disclosure, including methods having greater than or fewer than the number of steps illustrated, as understood from the discussions herein.

Methods 100 generally include sparking an initial plasma channel (e.g., initial plasma channel 32) via an auxiliary power source of a spark initiator (e.g., auxiliary power source 14 of spark initiator 10), at 102, and mechanically stretching the initial plasma channel to form an elongated stretch of plasma (e.g., elongated stretch of plasma 36), at 104, by spinning a dielectric disk (e.g., dielectric disk 16) of the spark initiator relative to a substrate being tested (e.g., substrate 12). Methods 100 also may include lowering a voltage received by a probe of a main power source (e.g., probe 28 of main power source 20) to a level that is safe for a capacitor bank assembly (e.g., capacitor bank assembly 22) of the main power source, at 106. In some examples, lowering the voltage at 106 includes lowering the voltage to a level at least below 50kV. Additionally or alternatively, lowering the voltage at 106 may include manipulating the voltage level that reaches the probe of the main power source, and/or controlling the voltage at the reattachment point to the main capacitor bank assembly, such as by selectively adjusting a resistance ratio of the initial plasma channel to the elongated stretch of plasma (e.g., using metallic strip 64).

In some methods 100, the elongated stretch of plasma is shaped at 108. For example, a length, a diameter, and/or a geometry of the elongated stretch of plasma may be controlled at 108. Additionally or alternatively, methods 100 may include controlling a speed of rotation of the dielectric disk at 110. For example, the rotation of the dielectric disk may be sped up or slowed down at 110, to create a desired change in the plasma channel created by the spark initiator. Methods 100 generally are performed without pricking, piercing, or puncturing the substrate, and may be used in direct lightning effect testing, or in other applications where it is desired to create a spark on a substate.

Illustrative, non-exclusive examples of inventive subject matter according to the present disclosure are described in the following enumerated paragraphs:
A1. A high-voltage wire-free spark initiator (10) for performing lightning testing on a substrate (12), the spark initiator (10) comprising:
   an auxiliary power source (14), wherein the auxiliary power source (14) is a high-voltage and low current power source, wherein the auxiliary power source (14) produces a sufficiently high initial voltage to establish a spark and an initial plasma channel (32) on the substrate (12);
   a dielectric disk (16) configured to be rotated with respect to the substrate (12), wherein the dielectric disk (16) comprises first and second opposing sidewalls (48, 50), and a circumferential surface (30) extending between the first and second opposing sidewalls (48, 50);
   a high-voltage electrode (18) positioned inside the dielectric disk (16); and
   a main high-voltage power source (20) comprising a capacitor bank assembly (22) and a dielectric ball (24) coupled to a distal end (26) of a probe (28) of the main high-voltage power source (20), wherein the dielectric ball (24) is positioned adjacent the circumferential surface (30) of the dielectric disk (16);
   wherein rotation of the dielectric disk (16) is configured to mechanically stretch the initial plasma channel (32) to form an elongated stretch of plasma (36) that reaches to the substrate (12).
A1.1. The spark initiator (10) of paragraph A1, wherein the spark initiator (10) is configured to create a main plasma channel (38) extending from the probe (28) to the substrate (12).
A2. The spark initiator (10) of paragraph A1 or A1.1, wherein the spark initiator (10) is configured to lower the initial voltage from the auxiliary power source (14) to a lower voltage that is safe for the capacitor bank assembly (22) of the main high-voltage power source (20).
A2.1. The spark initiator (10) of paragraph A1, wherein the lower voltage is below 50 kV.
A3. The spark initiator (10) of any of paragraphs A1-A2.1, wherein a capacitive discharge of the probe (28) decrease rapidly when the initial plasma channel (32) is stretched via rotation of the dielectric disk (16), due to a limited current supply of the main high-voltage power source (20).
A4. The spark initiator (10) of any of paragraphs A1-A3, further comprising a dielectric pulley assembly (52) configured to drive and rotate the dielectric disk (16).
A5. The spark initiator (10) of paragraph A4, wherein the dielectric pulley assembly (52) is electrically isolated.
A6. The spark initiator (10) of any of paragraphs A1-A5, wherein the capacitor bank assembly (22) operates at a lower peak voltage than the auxiliary power source (14).
A7. The spark initiator (10) of any of paragraphs A1-A6, wherein the initial voltage produced by the auxiliary power source (14) is sufficiently high to penetrate a dielectric coating of the substrate (12).
A8. The spark initiator (10) of any of paragraphs A1-A7, wherein the auxiliary power source (14) electrically couples the substrate (12) to the capacitor bank assembly (22) via the probe (28) near the circumferential surface (30) of the dielectric disk (16), without damaging the capacitor bank assembly (22).
A9. The spark initiator (10) of any of paragraphs A1-A8, wherein the spark initiator (10) is configured to cause the elongated stretch of plasma (36) to jump to the probe (28) when the probe (28) is near the elongated stretch of plasma (36).
A10. The spark initiator (10) of any of paragraphs A1-A9, wherein the spark initiator (10) is configured to perform, or be used in, direct lightning effect testing.
A11. The spark initiator (10) of any of paragraphs A1-A10, wherein the substrate (12) is a composite substrate having one or more layers of a high dielectric coating and/or paint, and wherein the spark initiator (10) is configured for testing the substrate (12) without pricking, puncturing, or piercing through the one or more layers.
A12. The spark initiator (10) of any of paragraphs A1-A11, wherein the dielectric disk (16) comprises a through-hole (40) formed through the circumferential surface (30), and wherein the elongated stretch of plasma (36) extends from the high-voltage electrode (18), through the through-hole (40), and along the circumferential surface (30) of the dielectric disk (16) to the substrate (12).
A13. The spark initiator (10) of paragraph A12, wherein the through-hole (40) comprises a ceramic rim.
A14. The spark initiator (10) of any of paragraphs A1-A13, wherein the dielectric disk (16) comprises a metallic rod (42) extending through the circumferential surface (30), and wherein the elongated stretch of plasma (36) extends from the high-voltage electrode (18) to the circumferential surface (30) of the dielectric disk (16) via the metallic rod (42).
A15. The spark initiator (10) of any of paragraphs A1-A14, further comprising an inner disk (44) positioned within the dielectric disk (16), wherein the high-voltage electrode (18) is positioned between the inner disk (44) and the dielectric disk (16).
A16. The spark initiator (10) of any of paragraphs A1-A15, wherein the dielectric disk (16) comprises a dielectric tube (54) extending through a central portion (56) of the dielectric disk (16), wherein the dielectric tube (54) extends longitudinally along an axis (58) about which the dielectric disk (16) is rotated, and wherein the high-voltage electrode (18) is positioned within the dielectric tube (54).
A17. The spark initiator (10) of any of paragraphs A1-A16, further comprising a metallic strip (64) that extends along a portion of the circumferential surface (30) of dielectric disk (16).
A18. The spark initiator (10) of paragraph A17, wherein the metallic strip (64) is configured to control a voltage at a reattachment point to the capacitor bank assembly (22) of the main high-voltage power source (20).
B1. A system (11), comprising: the spark initiator (10) of any of paragraphs A1-A18; and the substrate (12).
B2. The system (11) of paragraph B1, wherein the substrate (12) is a component of an aircraft.
C1. A method (100), comprising:
sparking (102) an initial plasma channel (32) via the auxiliary power source (14) of the spark initiator (10) of any of paragraphs A1-A18; and mechanically stretching (104) the initial plasma channel (32) to form the elongated stretch of plasma (36) by spinning the dielectric disk (16) relative to the substrate (12).
C2. The method (100) of paragraph C1, further comprising lowering (106) a voltage received by the probe (28) to a level that is safe for the capacitor bank assembly (22) of the main high-voltage power source (20).
C3. The method (100) of paragraph C2, wherein the level is below 50kV.
C4. The method (100) of any of paragraphs C1-C3, wherein the sparking (102) is performed without pricking, piercing, or puncturing the substrate (12).
C5. The method (100) of any of paragraphs C1-C4, further comprising shaping (108) the elongated stretch of plasma (36).
C6. The method (100) of any of paragraphs C1-C5, further comprising controlling (110) a speed of rotation of the dielectric disk (16).
C7. The method (100) of any of paragraphs C1-C6, further comprising controlling a length, a diameter, and/or a geometry of the elongated stretch of plasma (36).
C8. The method (100) of any of paragraphs C1-C7, further comprising manipulating a voltage level that reaches the probe (28) of the main high-voltage power source (20).
C9. The method (100) of any of paragraphs C1-C8, further comprising selectively adjusting a resistance ratio of the initial plasma channel (32) to the elongated stretch of plasma (36).
D1. The use of the spark initiator (10) of any of paragraphs A1-A18 or the system (11) of any of paragraphs B1-B2 to perform direct lightning effects testing on a composite substrate (12).
D2. The use of the spark initiator (10) of any of paragraphs A1-A18 or the system (11) of any of paragraphs B1-B2 to mechanically stretch the initial plasma channel (32) created by the auxiliary power source (14).

As used herein, the terms “selective” and “selectively,” when modifying an action, movement, configuration, or other activity of one or more components or characteristics of an apparatus, mean that the specific action, movement, configuration, or other activity is a direct or indirect result of dynamic processes and/or user manipulation of an aspect of, or one or more components of, the apparatus. The terms “selective” and “selectively” thus may characterize an activity that is a direct or indirect result of user manipulation of an aspect of, or one or more components of, the apparatus, or may characterize a process that occurs automatically, such as via the mechanisms disclosed herein.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including entities other than B); in another example, to at least one, optionally including more than one, B, with no A present (and optionally including entities other than A); in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” may mean A alone, B alone, C alone, A and B together, A and C together, B and C together, or A, B, and C together, and optionally any of the above in combination with at least one other entity.

As used herein, the phrase “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, a first direction that is at least substantially parallel to a second direction includes a first direction that is within an angular deviation of 22.5° relative to the second direction and also includes a first direction that is identical to the second direction.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

As used herein, the phrase, “for example,” the phrase, “as an example,” and/or simply the term “example,” when used with reference to one or more components, features, details, structures, examples, and/or methods according to the present disclosure, are intended to convey that the described component, feature, detail, structure, example, and/or method is an illustrative, non-exclusive example of components, features, details, structures, examples, and/or methods according to the present disclosure. Thus, the described component, feature, detail, structure, example, and/or method is not intended to be limiting, required, or exclusive/exhaustive; and other components, features, details, structures, examples, and/or methods, including structurally and/or functionally similar and/or equivalent components, features, details, structures, examples, and/or methods, are also within the scope of the present disclosure.

1. A high-voltage wire-free spark initiator for performing lightning testing on a substrate, the spark initiator comprising:
an auxiliary power source, wherein the auxiliary power source is a high-voltage and low current power source, wherein the auxiliary power source produces a sufficiently high initial voltage to establish a spark and an initial plasma channel on the substrate;
a dielectric disk configured to be rotated with respect to the substrate, wherein the dielectric disk comprises first and second opposing sidewalls, and a circumferential surface extending between the first and second opposing sidewalls;
a high-voltage electrode positioned inside the dielectric disk; and
a main high-voltage power source comprising a capacitor bank assembly and a dielectric ball coupled to a distal end of a probe of the main high-voltage power source, wherein the dielectric ball is positioned adjacent the circumferential surface of the dielectric disk;
wherein rotation of the dielectric disk is configured to mechanically stretch the initial plasma channel to form an elongated stretch of plasma that reaches to the substrate.

2. The spark initiator according to claim 1, wherein the spark initiator is configured to lower the initial voltage from the auxiliary power source to a lower voltage that is safe for the capacitor bank assembly of the main high-voltage power source, wherein the lower voltage is below 50 kV.

3. The spark initiator according to claim 1, further comprising a dielectric pulley assembly configured to drive and rotate the dielectric disk.

4. The spark initiator according to claim 3, wherein the dielectric pulley assembly is electrically isolated.

5. The spark initiator according to claim 1, wherein the capacitor bank assembly operates at a lower peak voltage than the auxiliary power source.

6. The spark initiator according to claim 1, wherein the initial voltage produced by the auxiliary power source is sufficiently high to penetrate a dielectric coating of the substrate.

7. The spark initiator according to claim 1, wherein the auxiliary power source electrically couples the substrate to the capacitor bank assembly via the probe near the circumferential surface of the dielectric disk, without damaging the capacitor bank assembly.

8. The spark initiator according to claim 1, wherein the spark initiator is configured to cause the elongated stretch of plasma to jump to the probe when the probe is near the elongated stretch of plasma.

9. The spark initiator according to claim 1, wherein the spark initiator is configured to perform, or be used in, direct lightning effects testing.

10. The spark initiator according to claim 1, wherein the substrate is a composite substrate having one or more layers of a high dielectric coating and/or paint, and wherein the spark initiator is configured for testing the substrate without pricking, puncturing, or piercing through the one or more layers.

11. The spark initiator according to claim 1, wherein the dielectric disk comprises a through-hole formed through the circumferential surface, and wherein the elongated stretch of plasma extends from the high-voltage electrode, through the through-hole, and along the circumferential surface of the dielectric disk to the substrate.

12. The spark initiator according to claim 11, wherein the through-hole comprises a ceramic rim.

13. The spark initiator according to claim 1, wherein the dielectric disk comprises a metallic rod extending through the circumferential surface, and wherein the elongated stretch of plasma extends from the high-voltage electrode to the circumferential surface of the dielectric disk via the metallic rod.

14. The spark initiator according to claim 1, further comprising an inner disk positioned within the dielectric disk, wherein the high-voltage electrode is positioned between the inner disk and the dielectric disk.

15. The spark initiator according to claim 1, wherein the dielectric disk comprises a dielectric tube extending through a central portion of the dielectric disk, wherein the dielectric tube extends longitudinally along an axis about which the dielectric disk is rotated, and wherein the high-voltage electrode is positioned within the dielectric tube.

16. A method, comprising:
sparking an initial plasma channel via the auxiliary power source of the spark initiator according to claim 1; and
mechanically stretching the initial plasma channel to form the elongated stretch of plasma by spinning the dielectric disk relative to the substrate.

17. The method according to claim 16, further comprising lowering a voltage received by the probe to a level that is safe for the capacitor bank assembly of the main high-voltage power source, wherein the level is below 50kV.

18. The method according to claim 16, wherein the sparking is performed without pricking, piercing, or puncturing the substrate.

19. The method according to claim 16, further comprising controlling a speed of rotation of the dielectric disk.

20. The method according to claim 16, further comprising controlling a length, a diameter, and/or a geometry of the elongated stretch of plasma.
